(19) United States
(12) Patent Application Publication
(10) Pub. No.: US 2024/0193067 A1
(43) Pub. Date: Jun. 13, 2024

(54) SYSTEM ON CHIP AND OPERATING METHOD THEREOF

(71) Applicant: Samsung Electronics Co., Ltd., Suwon-si (KR)

(72) Inventor: Moongyung KIM, Suwon-si (KR)

(73) Assignee: Samsung Electronics Co., Ltd., Suwon-si (KR)

(21) Appl. No.: 18/534,262

(22) Filed: Dec. 8, 2023

(30) Foreign Application Priority Data
Dec. 12, 2022 (KR) 10-2022-0173044

(51) Int. Cl. G06F 11/34

(52) U.S. Cl. CPC G06F 11/3409

(57) ABSTRACT

A system on chip includes a processor configured to execute an application by using a shared library, the application being supported by an operating system, a performance prediction module configured to generate control information of the processor for executing a function by the processor and predictive performance information of the processor that is predicted during control according to the control information when the function included in the shared library is executed the control information referencing a history corresponding to the function from a history table, and a performance management module configured to generate a control signal for performance control of the processor based on the control information, wherein the history is an accumulation of performance information of the processor measured by executing in advance the function at least once.

### CROSS-REFERENCE TO RELATED APPLICATION

This application is based on and claims priority under 35 U.S.C. § 119 to Korean Patent Application No. 10-2022-0173044, filed on Dec. 12, 2022, in the Korean Intellectual Property Office, the disclosure of which is incorporated by reference herein in its entirety.

### BACKGROUND

The inventive concepts relate to a system on chip, and an operating method of the system on chip.

A processor of a known operating system (OS) uses various performance control techniques including a dynamic frequency scaling (DFS) technique or a dynamic voltage and frequency scaling (DVFS) technique to satisfy both performance requirement and low power requirement for executing an application.

In particular, the known OS uses a dynamic performance control technique that predicts and controls performance by collecting information on a current operating state of a processor and predicting the operating state of a future processor.

However, the information on the operating state of the processor is information on hardware factors, and predictive performance information based thereon does not reflect performance of software factors, such as a function of an application, and accordingly, an error range of prediction performance increases, and immediate control according to a situation is difficult, resulting in unnecessary power/energy consumption and inefficient processing.

### SUMMARY

The inventive concepts provide a system on chip that may perform energy-efficient performance control by predicting performance in a function unit and an operating method of the system on chip.

The inventive concepts are not limited to the technical objects described above, and other technical objects that are not described may be clearly understood to those skilled in the art from the following descriptions.

According to an example embodiment of the inventive concepts, a system on chip includes a processor configured to execute an application by using a shared library, the application being supported by an operating system, a performance prediction module configured to generate control information of the processor for executing a function by the processor and predictive performance information of the processor that is predicted during control according to the control information when the function included in the shared library is executed, the control information referencing a history corresponding to the function from a history table, and a performance management module configured to generate a control signal for performance control of the processor based on the control information, wherein the history is an accumulation of performance information of the processor measured by executing in advance the function at least once.

According to another example embodiment of the inventive concepts, an operating method of a system on chip includes executing an application by using a shared library, the application being supported by an operating system, generating control information of a processor for executing a function and predictive performance information of the processor that is predicted during control according to the control information when the function included in the shared library is executed, the control information referencing a history corresponding to the function from a history table, and generating a control signal for performance control of the processor based on the control information, wherein the history is an accumulation of performance information of the processor measured by executing in advance the function at least once.

According to another example embodiment of the inventive concepts, an operating method of a system on chip includes executing an application supported by an operating system, identifying whether a history corresponding to a function used to execute the application is present in a history table, generating control information of a processor for executing the function and predictive performance information of the processor that is predicted during control according to the control information when the history corresponding to the function is present in the history table, the control information referencing the history corresponding to the function while the function is executed, and generating a control signal for performance control of the processor based on the predictive performance information, wherein the history is an accumulation of performance information of the processor measured by executing in advance the function at least once.

### BRIEF DESCRIPTION OF THE DRAWINGS

Example embodiments will be more clearly understood from the following detailed description taken in conjunction with the accompanying drawings in which:

FIG. 1 is a block diagram schematically illustrating a system on chip (SoC) according to an example embodiment;

FIG. 2 is a block diagram illustrating a performance controller according to an example embodiment;

FIG. 3 is a flowchart illustrating an operating method of an SoC, according to an example embodiment;

FIG. 4 is a flowchart illustrating an operating method of an SoC, according to another example embodiment;

FIG. 5 is a flowchart illustrating the history update operation of an SoC, according to an example embodiment;

FIG. 6A is a diagram illustrating a history entry according to an example embodiment;

FIG. 6B is a diagram illustrating a subfield of the history entry according to an example embodiment;

FIG. 7 is a block diagram illustrating a control system of an SoC, according to an example embodiment;

FIG. 8 is a block diagram illustrating a computer system including an SoC, according to an example embodiment;

FIG. 9 is a block diagram illustrating an electronic device including a performance controller, according to an example embodiment;

FIG. 10 is a block diagram illustrating an SoC according to an example embodiment; and

FIG. 11 is a block diagram illustrating an SoC according to an example embodiment.

### DETAILED DESCRIPTION OF THE EXAMPLE EMBODIMENTS

Certain structures or functions of example embodiments according to the inventive concepts disclosed herein are to describe the example embodiments according to the inventive concepts, and example embodiments according to the inventive concepts may be embodied in various forms and are not limited to the example embodiments described herein.

Hereinafter, example embodiments will be described in detail with reference to the accompanying drawings.

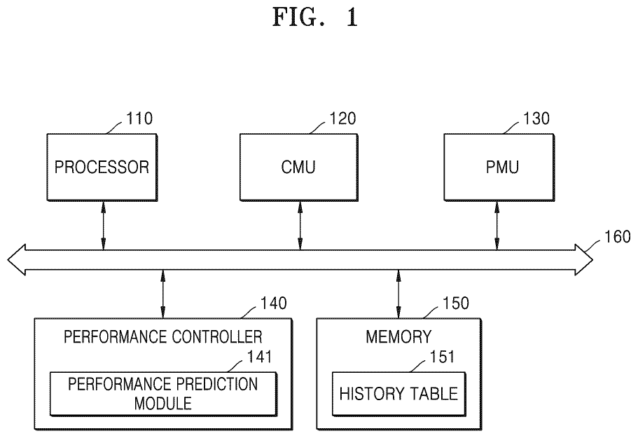

FIG. 1 is a block diagram schematically illustrating a system on chip (SoC) 100 according to an example embodiment.

Referring to FIG. 1, the SoC 100 may include a processor 110, a clock management unit (CMU) 120, a power management unit (PMU) 130, a performance controller 140, and a memory 150. The processor 110 and the performance controller 140 may be processing circuitry. Or restated, the SOC may include processing circuitry including the processor 110 and the performance controller 140.

The SoC 100 may be implemented as a personal computer (PC) or a mobile device. For example, the mobile device may include, for example, a laptop computer, a mobile phone, a smartphone, a tablet PC, a personal digital assistant (PDA), an enterprise digital assistant (EDA), a digital video camera, a portable multimedia player (PMP), a personal navigation device or a portable navigation device (PND), a handheld game console, a mobile internet device (MID), a wearable computer, an Internet of things (IoT) device, an Internet of everything (IoE) device, a drone, or an e-book, but is not limited thereto.

The processor 110, the CMU 120, the PMU 130, the performance controller 140, and the memory 150 may exchange data through a bus 160. The bus 160 may be implemented by an advanced microcontroller bus architecture (AMBA), an advanced high-performance bus (AHB), an advanced peripheral bus (APB), an advanced extensible interface (AXI), an advanced system bus (ASB), an AXI coherency extension (ACE), or a combination thereof, but is not limited thereto.

The processor 110 may include a control circuit, an integrated circuit, a motherboard, a microprocessor, an application processor (AP), a mobile AP, a chipset, or a set of semiconductor chips, but is not limited thereto.

In one example embodiment, when an application supported by an operating system (OS) is executed, the processor 110 may load, to an internal memory (for example, a eache memory) thereof, the application, functions required (or alternatively, used) to execute the application, a shared library, and history information associated with the functions.

In this case, the shared library may be supported by the OS and may indicate a library including various functions commonly provided to multiple applications.

In one example embodiment, the processor 110 may execute the application by using the shared library when there is the same function as a function in the shared library among a plurality of functions included in application execution code.

In one example embodiment, the processor 110 may control performance when executing an application and/or a function included in the application in response to a control signal received from the performance controller 140.

The CMU 120 may control frequencies of respective clock signals by using a clock control signal. The frequencies of the respective clock signals may be the same as and different from each other.

The PMU 130 may generate a control signal by using a power control signal and output the control signal to a power management IC (PMIC) to control a level of an operating voltage supplied to components included in a system.

In one example embodiment, dynamic voltage scaling (DVS), dynamic frequency scaling (DFS), or dynamic voltage and frequency scaling (DVFS) may be performed (or controlled) under control by the CMU 120 and the PMU 130.

In one example embodiment, the processor 110, the CMU 120, and the PMU 130 may control performance (for example, an operating frequency, an operating voltage, throttling, and so on) when executing an application and/or a function included in the application in response to a control signal received from the performance controller 140.

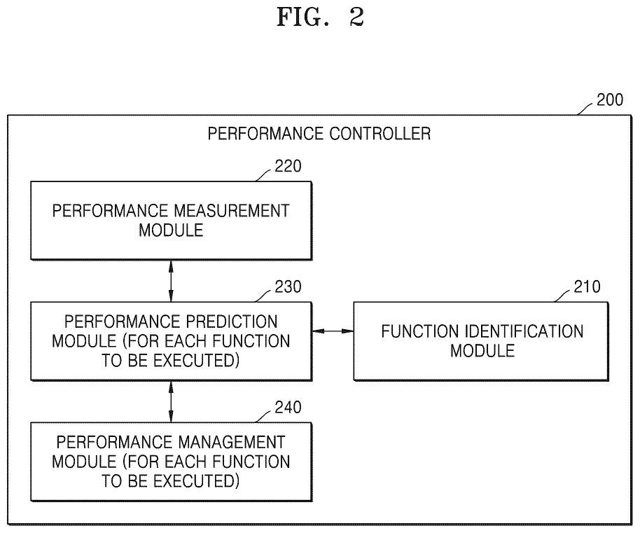

The performance controller 140 may include a performance prediction module 141. Although FIG. 1 illustrates that the performance controller 140 including only the performance prediction module 141, but the inventive concepts are not limited thereto, and detailed descriptions of the other modules included in the performance controller 140 are provided below with reference to FIG. 2. The performance controller 140 may perform various functions including functions not discussed herein and may include processing circuitry to implement the various functions. The performance controller 140 may operate based on instructions stored in a memory or may operate based on preprogrammed functions (for example, if the performance controller includes an field programmable gate array).

In one example embodiment, the performance controller 140 may identify functions for executing an application by using the performance prediction module 141, predict performance of the processor 110 by using history of each function of a history table 151 stored in the memory 150 when each function is executed, and generate a control signal for the processor 110 based on predictive performance information.

In one example embodiment, the performance controller 140 may generate a clock control signal and a power control signal by using history and software components (or hardware components), output the clock control signal to the CMU 120, and output the power control signal to the PMU 130. The power control signal may also be called a voltage control signal.

The memory 150 may include random access memory (RAM), dynamic RAM (DRAM), or static RAM (SRAM) but is not limited thereto. In one example embodiment, the memory 150 may be implemented as a non-volatile memory device.

The non-volatile memory device may be implemented as a flash-based storage but is not limited thereto. For example, the flash-based storage may include a solid-state drive or solid-state disk (SSD), an embedded SSD (eSSD), a universal flash storage (UFS), a multimedia card (MMC), an embedded MMC (eMMC), or managed NAND but is not limited thereto.

In one example embodiment, the memory 150 may store the history table 151. The history table 151 may be generated from the accumulated performance information obtained by accumulating pieces of performance information of the processor 110 measured by executing in advance a function for executing an application at least once.

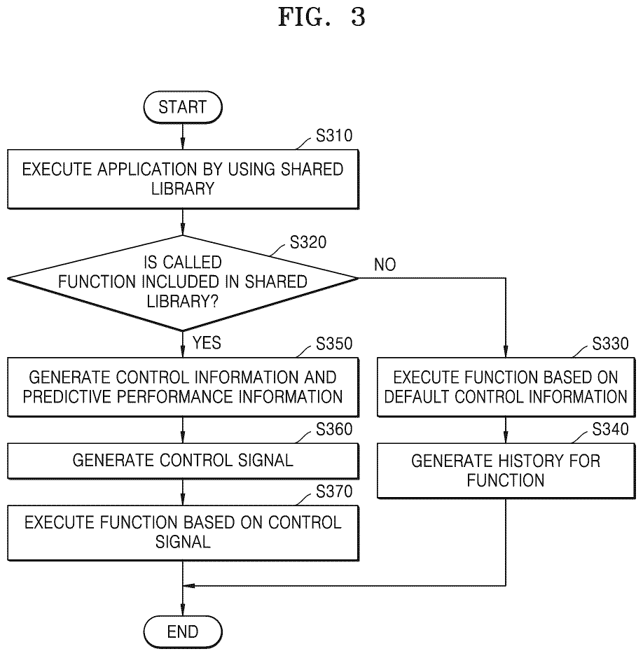

Herein, according to a first example embodiment for performance prediction control of the processor 110, when a called function is included in the shared library, the performance controller 140 of the SoC 100 may generate control information and predictive performance information for the processor 110 by using history of the called function while a function is executed and may perform the performance control of the processor 110 in response to a control signal. Description of the first example embodiment is made below with reference to FIG. 3.

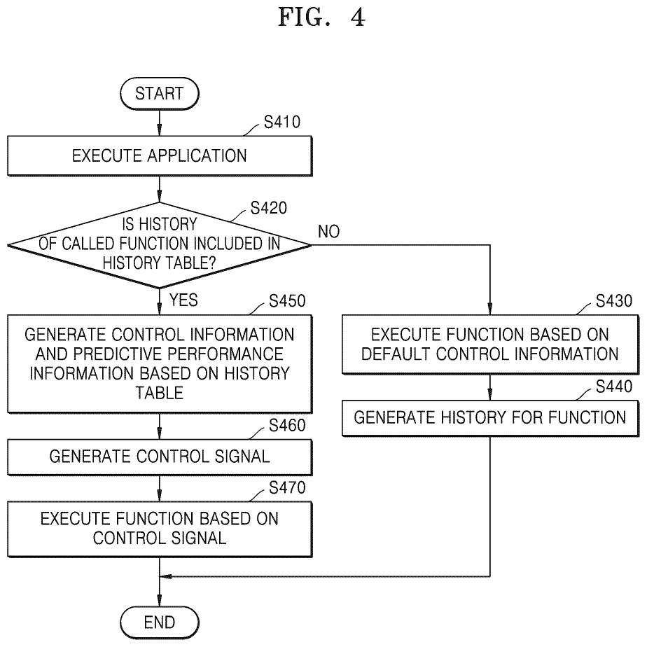

Herein, according to a second example embodiment for performance prediction control of the processor 110, when a history of the called function is present in the history table 151, the performance controller 140 of the SoC 100 may generate control information and predictive performance information for the processor 110 by using the history of the called function while a function is executed and may perform the performance control of the processor 110 in response to a control signal. Descriptions of the second example embodiment are made below with reference to FIG. 4.

FIG. 2 is a block diagram illustrating a performance controller according to an example embodiment.

Specifically, a performance controller 200 of FIG. 2 corresponds to the performance controller 140 of FIG. 1.

The performance controller 200 may be operated by an OS. Herein, control of performance of a processor by the performance controller 200 may mean control of performance of a processor by the OS.

The performance controller 200 may include a function identification module 210, a performance measurement module 220, a performance prediction module 230, and a performance management module 240 to control performance in a function unit required (or alternatively, used) to execute an application supported by the OS, and the modules described above may be electrically connected to each other to transmit and receive data or signals. Each of the modules of the performance controller 200 may be hardware circuit such as a portion of a field programmable gate array.

The function identification module 210 may detect a call of a function based on instruction information received from a processor.

In one example embodiment, the function identification module 210 may identify whether the called function is included in the shared library based on a result of comparing an address (for example, a start address) of the called function with addresses of functions included in the shared library.

In one example embodiment, the function identification module 210 may identify whether a history corresponding to the called function is present in the history table, based on the result of comparing the address (for example, a start address) of the called function with the addresses of the functions included in the history table.

The performance measurement module 220 may generate actual performance information by measuring performance of a processor while executing a function from the time when the function is called, and may transmit the generated actual performance information to the performance prediction module 230.

Herein, the actual performance information may include at least one of information on an operating voltage and an operating frequency that are actually applied to a processor when the function is executed, internal state monitoring information of the processor, temperature information of the processor, actual throttling information, setting information for active clock gating, and utilization information of an execution module.

The performance prediction module 230 may generate predictive performance information of a processor when a function is executed.

In one example embodiment, when the called function is included in the shared library, the performance prediction module 230 may generate control information and predictive performance information by using a history corresponding to the called function while a function is executed and may transmit pieces of the generated information to the performance management module 240.

In one example embodiment, when the history corresponding to the called function is included in a history table, the performance prediction module 230 may generate control information and predictive performance information by using the history corresponding to the called function while the function is executed.

Herein, the history corresponding to the called function may be defined as information generated by accumulating pieces of performance information of a processor measured by executing the function at least once before.

In one example embodiment, the performance prediction module 230 may transmit the generated control information and predictive performance information to the performance management module 240. In this case, the performance prediction module 230 may be connected to and the performance management module 240 through a path for transmission and reception of the control information and the predictive performance information.

In one example embodiment, the performance prediction module 230 may generate the control information and the predictive performance information by processing a history according to an operating state of a processor at the time the function is called.

Herein, the predictive performance information may include at least one of predictive power consumption information of a processor, information on an operating voltage and an operating frequency predicted to be provided to the processor, predictive temperature information of the processor, predictive throttling information of the processor, and information on an estimated measurement period. Detailed descriptions of operation of generating the predictive performance information, according to the example embodiment are made below with reference to FIGS. 3 and 4.

In one example embodiment, when the execution of the function is completed, the performance prediction module 230 may receive actual performance information of a processor measured while the function is executed according to the control information from the performance measurement module 220. The performance prediction module 230 may update the history of the function based on a result of comparing the actual performance information with the predictive performance information.

In one example embodiment, the performance prediction module 230 may identify the reliability of the predictive performance information by comparing the actual performance information and the predictive performance information.

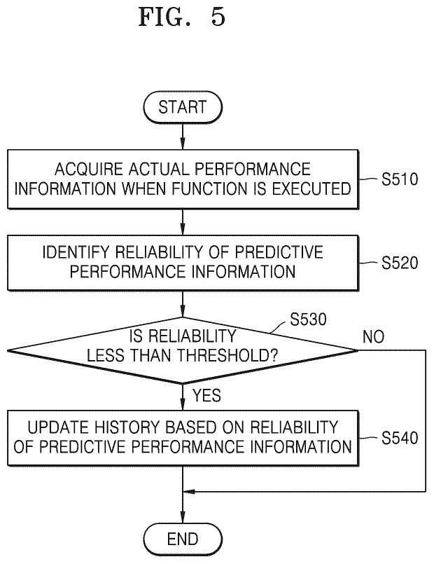

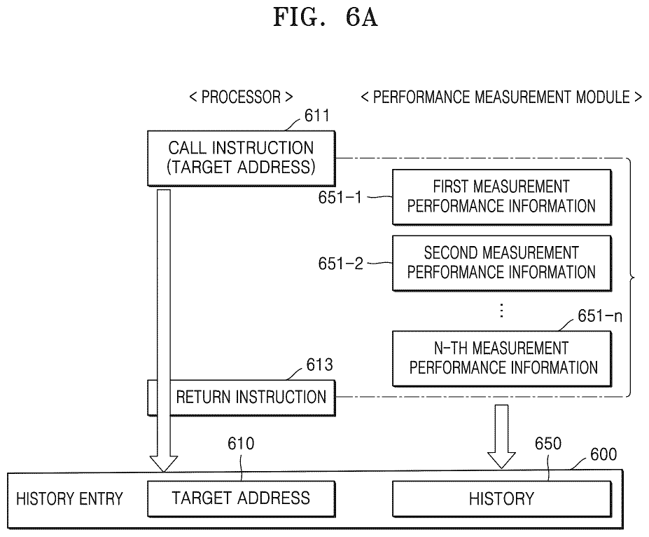

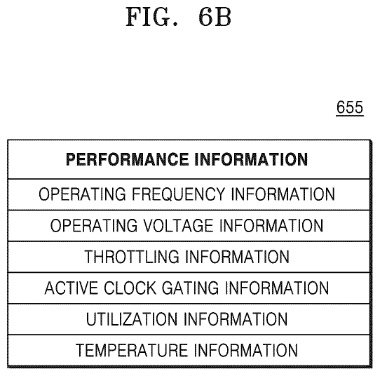

In one example embodiment, when reliability of the predictive performance information is less than a critical value, the performance prediction module 230 may update the history of the function based on the actual performance information. The critical value may be a threshold of accuracy (e.g., 80% accuracy). Herein, the updated history may be stored in the form of a history entry in the history table. Detailed descriptions of operation of the history update, according to the example embodiment are made below with reference to FIGS. 5 and 6A.

The performance management module 240 may generate a control signal for a processor when a function is executed based on the performance prediction information received from the performance prediction module 230. Herein, the control signal for the processor may be defined as a control signal for controlling an internal module or an internal circuit of the processor required (or alternatively, used) to execute a function.

Although it is described with reference to FIG. 2 that a control signal for a processor is generated by generating predictive performance information of the processor when a function of an application is executed, the inventive concepts are not limited thereto, and other modules (for example, pieces of internet protocol (IP), a micro-processing unit (MPU), a graphics processing unit (GPU), and so on) that may control performance of the SoC may also be controlled based on predictive performance information generation and the predictive performance information.

FIG. 3 is a flowchart illustrating an operating method of an SoC, according to an example embodiment.

Specifically, FIG. 3 illustrates the operation of generating predictive performance information and a control signal by using a history associated with a function when the function required (or alternatively, used) to execute an application execution is included in a shared library, according to a first example embodiment for performance prediction control of a processor of the inventive concepts. In this case, the shared library may be supported by an OS, which may indicate a library including various functions commonly provided to a plurality of applications.

Referring to FIG. 3, the operation of generating predictive performance information and a control signal for a function included in a shared library may include operation S310 to operation S370.

In operation S310, a processor of the SoC 100 may execute an application by using a shared library. Herein, executing an application may mean executing code corresponding to the application, specifically, executing functions included in the code. According to the example embodiment, when a processor executes functions, a performance controller may control performance of the processor by using a history table for functions included in the shared library among the functions. The performance controller may be operated by an OS executed by the processor.

In one example embodiment, the performance controller may detect a function call after the history table is generated. Herein, a history may mean information generated by accumulating pieces of performance information of a processor measured by executing in advance a function included in a shared library at least once, and may be linked to an address (for example, a start address of the function) of each of functions included in the shared library and stored in the history table.

In example embodiment, the performance controller may detect a call of a function based on the execution code (instruction) information (for example, a call instruction) received from a processor.

In operation S320, the performance controller may identify whether the called function is included in the shared library.

In one example embodiment, when the call of the function is detected, the performance controller may compare an address of the called function with an address of each of the functions included in the shared library, and accordingly, whether the called function is included in the shared library may be identified.

In one example embodiment, when the called function is included in the shared library, the performance controller may perform operation S340. When the called function is not included in the shared library, the performance controller may perform operation S330.

In operation S330, the performance controller of the SoC 100 may execute a function based on default control information. In one example embodiment, when the called function is included in the shared library, the performance controller may control performance of a processor by using the default control information while the function is executed.

In operation S340, the performance controller of the SoC 100 may generate a history of the function. The performance controller may acquire actual performance information of the processor by measuring performance or an operating state of the processor while the function is executed.

In one example embodiment, the performance controller may store an average performance value of the processor measured while the function is executed in the history table as a history for the function, and then when the function of the shared library is executed again, the performance controller may control the processor by predicting the performance of the processor based on the history.

In one example embodiment, when the called function is included in the shared library, the performance controller may identify a history associated with a function called from the history table based on the start address of the called function. The performance controller may generate control information of the processor for executing the function and predictive performance information for executing the function based on performance/operating state information of the current processor and the identified history.

Herein, the control information may be based on the performance/operating state information of a current processor and the identified history, and may mean control information for improving performance of the processor when the processor executes the function.

The predictive performance information may include at least one of power consumption information of the processor predicted when the performance of the processor is controlled according to the control information, information on an operating voltage and an operating frequency predicted to be provided to the processor, predictive temperature information of the processor, predictive throttling information of the processor, and information on an estimated measurement period.

In operation S360, the performance controller of the SoC 100 may generate a control signal. In one example embodiment, the performance controller may calculate power consumption, performance, temperature, and so on of a processor based on predictive performance information, and may generate the control signal for the processor by using a calculation result while the function is executed.

Herein, the control signal for the processor may be defined as a control signal for controlling an internal module or an internal circuit of the processor required (or alternatively, used) to execute the function.

In operation S370, the performance controller of the SoC 100 may execute the function required (or alternatively, used) to execute an application based on the control signal.

Although not illustrated, when the called function is not included in the shared library, the performance controller may execute a function based on default control information, and when the function is executed again by generating a history of actual performance information measured while the function is executed, the performance controller may perform performance prediction control by using the history.

Although it is described with reference to FIG. 3 that, when a function of an application is executed, predictive performance information and a control signal for a processor are generated by predicting performance of the processor by using a history, the inventive concepts is not limited thereto, and other modules (for example, pieces of IP, an MPU, a GPU, and so on) that may control performance of the SoC may also be controlled based on predictive performance information generation and the predictive performance information.

The SoC according to the example embodiment may predict a function in a function unit by generating predictive performance information and a control signal by using a history of functions of a shared library, and thus, it is possible to improve accuracy of performance prediction and to provide energy-efficient system control.

FIG. 3 illustrates an example embodiment of performance prediction control using a history of each function included in a shared library, when the shared library is used in an OS of the SoC 100.

FIG. 4 below illustrates another example embodiment of the performance prediction control using a history of each function included in an application, when a function included in the application is used in the OS.

FIG. 4 is a flowchart illustrating an operating method of an SoC according to another example embodiment.

Specifically, FIG. 4 illustrates the operation of generating predictive performance information and a control signal by using a history associated with a function, when a history corresponding to the function required (or alternatively, used) by the application is present in the history table, according to a second example embodiment for performance prediction control of a processor of the inventive concepts.

Referring to FIG. 4, the operation of generating predictive performance information and a control signal for a function included in an application may include operation S410 to operation S470.

In operation S410, a performance controller of the SoC 100 may execute the application. In one example embodiment, the meaning of executing the application according to the example embodiment may include loading the application and related files (for example, a function required (or alternatively, used) to execute the application and a history related thereto) from an external memory to a each memory of a CPU.

In one example embodiment, the performance controller of the SoC 100 may detect a function call after a history table is generated.

Herein, a history may mean information generated by accumulating pieces of performance information of a processor measured for a function that is executed in advance at least once among functions included in the application, and may be linked to an address (for example, a start address) of each of the functions included in the application and stored in the history table.

In operation S420, the performance controller of the SoC 100 may identify whether a history corresponding to a called function is present in the history table.

In one example embodiment, when a call of a function is detected, the performance controller may identify whether a history corresponding to the called function is present in the history table by using the start address of the called function.

In one example embodiment, when the history corresponding to the called function is present in the history table, the performance controller may perform operation S450. When the history corresponding to the called function is not present in the history table, the performance controller may perform operation S430.

In operation S430, the performance controller of the SoC 100 may execute a function based on default control information. In one example embodiment, when the history corresponding to the called function is not present in the history table, the performance controller may control performance of a processor when executing the function based on the default control information.

In operation S440, the performance controller of the SoC 100 may generate a history of the function.

The performance controller may acquire actual performance information of a processor by measuring performance or an operating state of the processor while the function is executed.

In one example embodiment, the performance controller may store an average performance value of a processor measured while the function is executed in a history table as a history of the function, and then, when the function is executed again, the performance controller may control the processor by predicting the performance of the processor based on the history.

In operation S450, the performance controller of the SoC 100 may generate control information and predictive performance information based on the history table.

In one example embodiment, when the called function is included in the application, the performance controller may identify a history linked to the function called from the history table based on the start address of the called function. The performance controller may generate the control information of a processor for executing a function and the predictive performance information according to the control information by processing the identified history based on performance and operating state information of the current processor.

Herein, the control information may be based on the performance/operating state information of the current processor and the identified history, and may mean control information for improving performance of a processor when the processor executes the function.

Herein, the predictive performance information may include at least one of power consumption information of a processor predicted when the processor operates according to the control information, information on an operating voltage and an operating frequency predicted to be provided to the processor, predictive temperature information of the processor, predictive throttling information of the processor, and information on an estimated measurement period.

In operation S460, the performance controller of the SoC 100 may generate a control signal. In one example embodiment, the performance controller may calculate power consumption, performance, and temperature of the processor based on the predictive performance information and may generate the control signal for the processor by using a calculation result when the function is executed.

In operation S470, the performance controller of the SoC 100 may execute a function required (or alternatively, used) to execute an application based on the control signal.

Although it is described with reference to FIG. 4 that when there is a history corresponding to the function as a function that is executed in advance at least once among functions required (or alternatively, used) to execute an application, predictive performance information and a control signal for the processor are generated by predicting the performance of a processor by using a history, the inventive concepts are not limited thereto, and other modules (for example pieces of IP, an MPU, a GPU, and so on) that may control performance of the SoC may also be controlled based on predictive performance information generation and the predictive performance information.

In the SoC and the operating method thereof according to the example embodiment, when a history table includes a history corresponding to a function that is executed in advance at least once among the functions included in application code, performance of a processor is predicted by using a history table while the function is executed, and accordingly, it is possible to prevent or reduce unnecessary power consumption and waste of resources based on actual performance data obtained by executing in advance the function and to efficiently control the performance of the processor based on accurate performance prediction.

FIG. 5 is a flowchart illustrating a history update operation of an SoC, according to an example embodiment.

Specifically, FIG. 5 is a flowchart illustrating the operation of updating a history associated with a function by using a performance controller of the SoC of FIG. 1.

Referring to FIG. 5, the operation of updating the history may include operation S510 to operation S540.

In operation S510, the performance controller of the SoC 100 may acquire actual performance information of a processor when a function is executed.

In one example embodiment, the performance controller may acquire actual performance information by measuring performance of a processor that executes a function from a call time of the function (for example, an execution time of the function) to a return time of the function (for example, an execution end time of the function) while the function is executed.

Herein, the actual performance information may include at least one of information on an operating voltage and an operating frequency that are actually applied to a processor when the function is executed, internal state monitoring information of the processor, temperature information of the processor, actual throttling information, setting information for active clock gating, and utilization information of an execution module.

In operation S520, the performance controller of the SoC 100 may identify the reliability of the predictive performance information. Herein, the reliability of predictive performance information may mean the degree of consistency between performance of a processor predicted by an OS and actual measured performance when a function is executed.

In one example embodiment, when the execution of the function ends, the performance controller may compare the actual performance information with the predictive performance information and calculate the degree of consistency between the pieces of information, and accordingly, the performance controller may identify the reliability of the predictive performance information.

In operation S530, the performance controller of the SoC 100 may determine whether the reliability of the predictive performance information is less than a threshold.

In one example embodiment, when the degree of consistency between the actual performance information and the predictive performance information of a processor is less than a reference value, the performance controller may determine that the reliability of the predictive performance information is less than the threshold. When the degree of consistency between the actual performance information and the predictive performance information of the processor is greater than the previously determined reference value, the performance controller may determine that the reliability of the predictive performance information is greater than the threshold.

In one example embodiment, when the reliability of the predictive performance information is less than the threshold, the performance controller may perform operation S540.

In one example embodiment, when the reliability of predictive performance information is greater than or equal to the threshold, the performance controller may skip update of a history.

In operation S540, the performance controller of the SoC 100 may update the history based on the reliability of predictive performance information.

In one example embodiment, when the reliability of the predictive performance information is less than the threshold, the performance controller may update a history of a function based on actual performance information. Herein, the updated history may be stored in a history table in the form of a history entry. Description of a format of the history entry is made below with reference to in FIG. 6A.

Although it is described with reference to FIG. 5 that a history is updated based on reliability of predictive performance information, the inventive concepts are not limited thereto, and the history may be updated every time a function is executed according to needs of a system or desires of the user.

In addition, the example embodiment in which a history is updated as described with reference to FIG. 5 may be applied to both the first example embodiment (described with reference to FIG. 3) and the second example embodiment (described with reference to FIG. 4) for performance prediction control of a processor of the inventive concepts.

In addition, although it is described with reference to FIG. 5 that a history is updated based on reliability of predictive performance information on a processor, the inventive concepts is not limited thereto, and other modules (for example, pieces of IP, an MPU, a GPU, and so on), which may control performance of an SoC, may perform performance prediction control by updating the history based on the reliability of the predictive performance information.

In the SoC and the operating method thereof according the example embodiment, when the function is executed, performance of a system may be predicted by using a history, and when the execution of the function ends, the history is updated by comparing predictive performance information of the system with actual performance information of the system, and thus, the accuracy of performance prediction of the system may be improved, and adaptive performance control may be provided according to a change in an internal state and environment of the system.

FIG. 6A is a diagram illustrating a history entry according to an example embodiment.

Specifically, the history entry for updating a history of FIG. 5 is illustrated.

Referring to FIG. 6A, a history entry 600 may include a target address field 610 and a history field 650.

The target address field 610 may acquire a start address of a called function based on execution code information received from a processor and store the start address of the called function as a target address. The execution code information may include information on a call instruction 611 or a return instruction 613.

In one example embodiment, when the call instruction 611 is detected, a performance controller may compare an address of the called function with an address stored in the target address field 610 of a history table to identify whether a history corresponding to the called function is a function included in the history table.

In one example embodiment, when the history corresponding to the called function is present in the history table, the performance controller may identify a history entry composed of the target address field 610 including a start address of the called function as the history entry 600 of the called function.

In one example embodiment, when the history corresponding to the called function is not present in the history table, the performance controller may generate the history entry 600 composed of the target address field 610 including the start address of the called function.

The history field 650 may store a history linked to the target address of the target address field 610 of the history entry 600.

In one example embodiment, when the history corresponding to the called function is present in the history table, the performance controller may update the history field 650 of the history entry 600 based on a result of comparing performance information (for example, actual performance information) to performance prediction information of a process measured while the called function is executed.

In one example embodiment, when the history corresponding to the called function is not present in the history table, the performance controller may update the history field 650 of the history entry 600 based on the performance information (for example, actual performance information) of the processor measured while the called function is executed.

Herein, the measured performance information of the processor may mean performance information (for example, first measurement performance information 651-1 to n-th measurement performance information 651-n) of the processor measured from a call time of a function of which the call instruction 611 is detected to an end time of a function of which the return instruction 613 is detected.

In one example embodiment, the measured performance information of the processor may be actual performance information and may include at least one of information on an operating voltage and an operating frequency that are actually applied to a processor when the function is executed, internal state monitoring information of the processor, temperature information of the processor, actual throttling information, setting information for active clock gating, and utilization information of an execution module.

In one example embodiment, the performance controller may update the history entry 600 by storing an average value of the first measurement performance information 651-1 to the n-th measurement performance information 651-n in the history field 650.

In one example embodiment, the performance controller may update the history entry 600 by storing an intermediate value of the first measurement performance information 651-1 to the n-th measurement performance information 651-n in the history field 650.

Although it is described with reference to FIG. 6A that a history entry (or a history table) is updated by measuring performance of a processor while a function is executed, the inventive concepts are not limited thereto, and other modules (for example, pieces of IP, an MPU, a GPU, and so on) that may control performance of an SoC may also update a history entry by using the measured performance information.

In addition, the example embodiment described for a history entry with reference to FIG. 5 may be applied to both the first example embodiment (described with reference to FIG. 3) and the second example embodiment (described with reference to FIG. 4) for performance prediction control of a processor of the inventive concepts.

FIG. 6B is a diagram illustrating a subfield of a history entry according to an example embodiment.

Specifically, FIG. 6B illustrates subfields 655 in the history field 650 of FIG. 6A.

Referring to FIG. 6B, the history field 650 of FIG. 6A may include an operating frequency information subfield, an operating voltage information subfield, a throttling information subfield, an active clock gating information subfield, a utilization information subfield, and a temperature information subfield.

The operating frequency information subfield may store information on an operating frequency of a clock signal provided to a processor when the processor executes a certain function.

The operating voltage information subfield may store an average value of pieces of sampling information on a size of an operating voltage provided to a processor when the processor executes a certain function.

The throttling information subfield may store information on the number of functional blocks that are controlled to be deactivated (or off) among functional blocks in a processor when the processor executes a certain function.

The active clock gating information subfield may store information on the number of functional blocks to which a clock signal is not applied because the functional blocks are not used for a certain period among functional blocks in the processor when the processor executes a certain function.

The utilization information subfield may store information on ratios of functional blocks that perform processing operations among activated function blocks in the processor when the processor executes a certain function.

The temperature information subfield may store information on temperature of a processor when the processor executes a certain function.

In one example, the performance controller may generate control information and predictive performance information to reduce an operating frequency or an operating voltage when a ratio indicated by a utilization information subfield in the history field referred to so as to control performance of a processor that executes a function is less than the operating frequency or the operating voltage.

In another example, the performance controller may generate the control information and the predictive performance information to reduce the operating frequency or the operating voltage when the temperature indicated by the temperature information subfield in the history field is higher than a reference temperature.

In another example, the performance controller may generate the control information and the predictive performance information to increase the number of functional blocks of a processor which is controlled to be deactivated (or off) when the amount of power consumption, which includes an operating frequency indicated by the operating frequency information subfield in the history field and the operating voltage indicated by the operating voltage information subfield in the history field, is greater than a reference amount of power.

In this way, the performance controller may generate the control information and the predictive performance information by considering individually or in combination various factors (an operating frequency, an operating voltage, throttling, active clock gating, utilization, and temperature) of a history.

The history field of FIG. 6B is only an example embodiment, and the inventive concepts are not limited thereto, and the history field may further include subfields corresponding to various factors corresponding to performance of a processor.

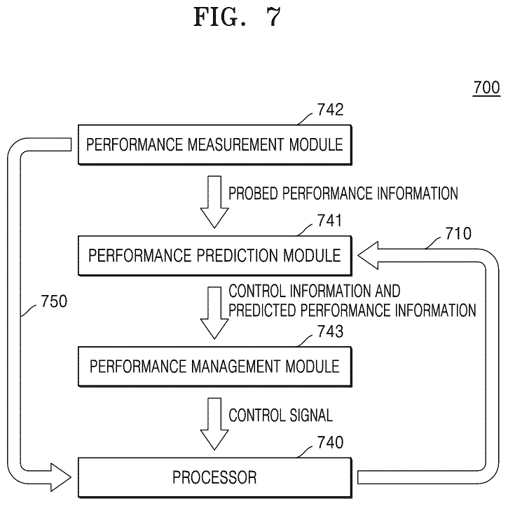

FIG. 7 is a block diagram illustrating a control system 700 of an SoC, according to an example embodiment.

Specifically, FIG. 7 illustrates the control system 700 included in the SoC. A processor 740, a performance prediction module 741, a performance measurement module 742, and a performance management module 743 in FIG. 7 may respectively correspond to the performance controller 140, the performance prediction module 230, the performance measurement module 220, and the performance management module 240. Restated, the control system 700 may include processing circuitry which includes the processor 740, a performance prediction module 741, a performance measurement module 742, and a performance management module 743.

Referring to FIG. 7, the control system 700 may include a processor 740, the performance prediction module 741, the performance measurement module 742, and the performance management module 743.

The processor 740 may provide the performance prediction module 741 with information 710 on execution code information of a called function to execute an application when detecting a call.

The performance prediction module 741 may identify whether a history corresponding to the called function is included in a history table, based on the received execution code information 710. In this case, the history table may be loaded as a file linked to an application that is loaded and a shared library (for example, a dynamic link library (DLL)) to execute the application.

When the history corresponding to the called function is present in the history table, the performance prediction module 741 may identify a history associated with the function by searching the history table for a start address of the called function. Herein, the history may indicate the information generated by accumulating pieces of performance information of the processor which is measured by executing in advance the function at least once.

The performance prediction module 741 may process a history by considering information on an operating state of the processor 740 measured by the performance measurement module 742, and when a function is executed, the performance prediction module 741 may generate control information and predictive performance information for the processor 740 and transmit the control information and the predictive performance information to the performance management module 743.

Herein, the control information may be based on performance/operating state information of a current processor and the identified history and may mean control information for improving performance of the processor when the processor executes the function.

Herein, the performance information may include at least one of power consumption information of the processor which is predicted, information on an operating voltage and an operating frequency predicted to be provided to the processor, predictive temperature information of the processor, predictive throttling information of the processor, and information on an estimated measurement period.

The performance management module 743 may generate a control signal for the processor 110 based on the received control information and the received predictive performance information to control the processor 740 while a function is executed.

The performance measurement module 742 may measure actual performance information 750 on performance and an operating state of the processor 740 while a function is executed. Herein, the actual performance information 750 may include at least one of information on an operating voltage and an operating frequency actually applied to the processor when the function is executed, internal state monitoring information of the processor, temperature information of the processor, actual throttling information, setting information on active clock gating, and utilization information of an execution module.

The performance prediction module 741 may identify the reliability of the predictive performance information through a result of comparing the predictive performance information with the actual performance information 750. The performance prediction module 741 may update a history (or a history table) associated with the function based on the reliability of the predictive performance information.

When unloading a shared library or an application by ending execution of the application, the processor 740 may unload the updated history (or the updated history table) together. In this case, the history may be stored by being linked to a start address of an associated function.

Although not illustrated in the drawings, the SoC and the operating method thereof according to the example embodiment may also be applied to a multi-processor system to provide predictive performance information to each individual processor and may be expanded to an example embodiment that provides system-optimized (or improved) performance control through machine learning (for example, training with a neural network) for predictive performance information.

In the SoC and the operating method thereof according to the example embodiment, performance of a system may be predicted by using a history of each of functions when a function is executed, and accordingly, performance prediction accuracy of the system based on a history acquired by executing in advance the function may be improved, and the performance of the system may be efficiently controlled.

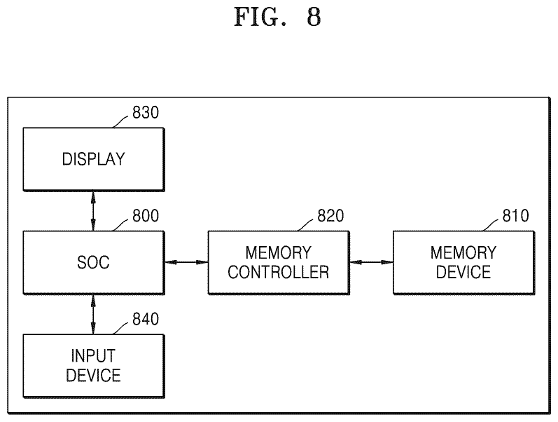

FIG. 8 illustrates a block diagram of a computer system including an SoC, according to an example embodiment.

Specifically, FIG. 8 illustrates a computer system including the SoC 100 of FIG. 1. An SoC 800 of FIG. 8 may correspond to the SoC 100 of FIG. 1.

Referring to FIG. 8, a computer system according to an example embodiment may include the SoC 800, a memory device 810, a memory controller 820 that may control a data processing operation of the memory device 810, a display 830, and an input device 840.

For example, the computer system including the SoC 800, according to the example embodiment, may be implemented by a PC, a network server, a tablet PC, a netbook, an e-reader, a PDA, a PMP, a moving picture experts group (MPEG)-1 audio layer 3 (MP3) player, or an MPEG-1 audio layer 4 (MP4) player.

The SoC 800 may display data (for example, a history table) stored in the memory device 810 on the display 830 according to data input through the input device 840.

In one example embodiment, the input device 840 may receive a control signal for controlling operation of the SoC 800 or data to be processed by the SoC 800 and may include a pointing device, such as a touch pad or a computer mouse, a keypad, or a keyboard.

The SoC 800 may control all operations of a computer system and control operation of the memory controller 820. In one example embodiment, the SoC 800 may store a history table required (or alternatively, used) to execute a function of a shared library or a function of an application in the memory device 810 through the memory controller 820, and when the functions are executed, the SoC 800 may receive the history table from the memory device 810 through the memory controller 820.

In one example embodiment, the SoC 800 may store actual performance information measured while the function is executed in the memory device 810 through the memory controller 820.

In one example embodiment, when the execution of the function ends, the SoC 800 may store a history table updated based on a result of comparing performance prediction information with the actual performance information in the memory device 810 through the memory controller 820.

In one example embodiment, the memory controller 820, which may control the operation of the memory device 810, may be implemented as part of the SoC 800 and may also be implemented as a chip separate from the SoC 800.

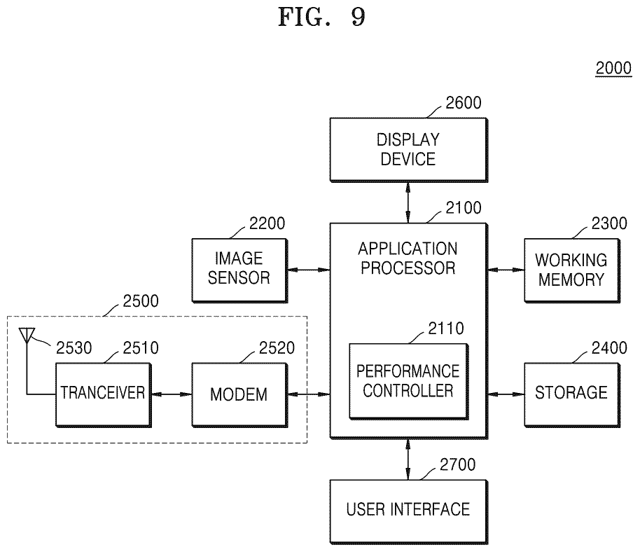

FIG. 9 is a block diagram illustrating an electronic device 2000 including a performance controller, according to an example embodiment. The electronic device 2000 of FIG. 9 may be a portable terminal.

Referring to FIG. 9, the electronic device 2000 may include an application processor 2100, an image sensor 2200, a display device 2600, a working memory 2300, a storage 2400, a user interface 2700, and a wireless transmission and reception unit 2500.

The application processor 2100 may be a main processor of the electronic device 2000 and may be implemented as an SoC that controls all operations of the electronic device 2000 and executes an application, an OS, and so on. The application processor 2100 may provide image data provided from the image sensor 2200 to the display device 2600 or store the image data in the storage 2400. The SoC may be applied as an application processor 2100.

The application processor 2100 may include a performance controller 2110. The operation of the performance controller 140 described with reference to FIGS. 1 to 9 may be applied to the performance controller 2110.

A plurality of functional blocks included in the application processor 2100 may access a shared resource, for example, the working memory 2300 through a system interconnection circuit.

When a function is executed, the performance controller 2110 may generate predictive performance information by processing a history based on an operating state of the application processor 2100 and may generate a control signal for the application processor 2100 by using the predictive performance information Herein, the history may mean information generated by accumulating pieces of the performance information of the application processor 2100 measured by executing in advance at least once the function.

The performance controller 2110 may acquire actual performance information of the application processor 2100 by using the control signal while the function is executed and may update a history of the function based on a result of comparing the predictive performance information with the actual performance information. Accordingly, by predicting performance of the application processor 2100 in a function unit when the application is executed, a system may perform efficient performance control for preventing (or reducing) resources from being wasted based on accurate performance prediction.

The working memory 2300 may include a volatile memory, such as DRAM or a SRAM, or a non-volatile memory, such as phase change RAM (PRAM) or resistive RAM (ReRAM). An operating program stored in the storage 2400, or an application program may be loaded into the working memory 2300 to be executed. In addition, data generated during operation of the electronic device 2000 may be stored temporarily in the working memory 2300.

The storage 2400 may include a non-volatile memory device, such as NAND flash or resistive memory and may be implemented as a memory card (an MMC, an eMMC, a secure digital (SD) card, or a micro SD card). The storage 2400 may store image data provided from the image sensor 2200. In addition, the storage 2400 may store an operating program, an application program, a shared library, a history table, and so on of the electronic device 2000.

The user interface 2700 may include various devices that may receive a user input, such as a keyboard, a curtain key panel, a touch panel, a fingerprint sensor, and a microphone. The user interface 2700 may receive a user input and provide a signal corresponding to the received user input to the application processor 2100.

The wireless transmission and reception unit 2500 may include a transceiver 2510, a modem 2520, and an antenna 2530. The wireless transmission and reception unit 2500 may perform wireless communication with an external device and receive data from the external device or transmit data to the external device.

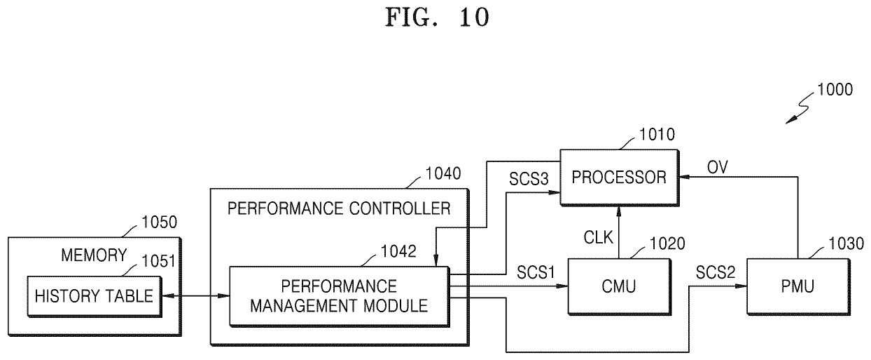

FIG. 10 is a block diagram illustrating an SoC according to an example embodiment.

Referring to FIG. 10, an SoC 1000 may include a processor 1010, a CMU 1020, a PMU 1030, a performance controller 1040, and a memory 1050.

The performance controller 1040 may include a performance management module 1042. In one example embodiment, the performance management module 1042 may generate a k-th control signal corresponding to k-th control information and k-th predictive performance information for controlling performance of the processor 1010 that executes a k-th function. The control signal may include a first sub-control signal SCS1 provided to the CMU 1020, a second sub-control signal SCS2 provided to the PMU 1030, and a third sub-control signal SCS3 provided to the processor 1010.

In one example embodiment, the CMU 1020 may adjust an operating frequency based on the first sub-control signal SCS1 and provide a clock signal CLK having the adjusted operating frequency to the processor 1010.

In one example embodiment, the PMU 1030 may adjust an operating voltage based on the second sub-control signal SCS2 and provide an adjusted operating voltage OV to the processor 1010.

In one example embodiment, the processor 1010 may perform throttling control and/or active clock gating control of functional blocks included in the processor 1010 based on the third sub-control signal SCS3.

In one example embodiment, the performance management module 1042 may generate k-th actual performance information by measuring actual performance of the processor 1010 according to the first, second, and third sub-control signals SCS1, SCS2, and SCS3.

The performance management module 1042 may compare the k-th predictive performance information corresponding to the k-th control information with the k-th actual performance information and may update a history table 1051 based on a result of the comparison. Specifically, the performance management module 1042 may update the known k-th history performance information of the history table 1051 as the k-th actual performance information when a difference between the k-th predictive performance information and the k-th actual performance information exceeds a reference difference. In some example embodiments, when the difference between the k-th predictive performance information and the k-th actual performance information exceeds the reference difference, the performance management module 1042 may update the existing k-th predictive performance information of the history table 1051 to an average value of the existing k-th predictive performance information and the k-th actual performance information.

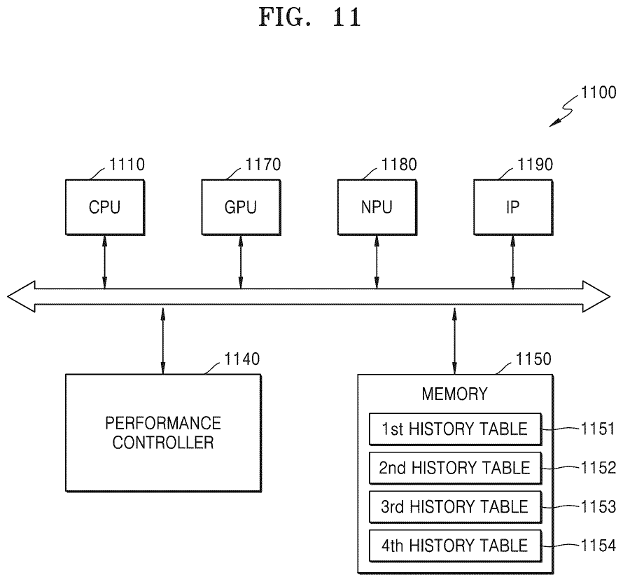

FIG. 11 is a block diagram illustrating an SoC according to an example embodiment.

Referring to FIG. 11, an SoC 1100 may include a central processing unit (CPU) 1110, a GPU 1170, a neural processing unit (NPU) 1180, certain intellectual property (IP) 1190, a performance controller 1140, and a memory 1150. Each of the CPU 1110, the GPU 1170, and the NPU 1180 may be referred to as IP.

In one example embodiment, the memory 1150 may include a first history table 1151 to a fourth history table 1154. The first history table 1151 may be used for performance control of the CPU 1110 of a function unit, the second history table 1152 may be used for performance control of the GPU 1170 of a function unit, the third history table 1153 may be used for performance control of the NPU 1180 of a function unit, and the fourth history table 1154 may be used for performance control of the random IP 1190 of a function unit,

In one example embodiment, the CPU 1110 may execute a first code corresponding to at least one first application, and the first code may include a plurality of first functions. The first history table 1151 may store a plurality of pieces of first history performance information respectively corresponding to the plurality of first functions.

In one example embodiment, the GPU 1170 may execute a second code corresponding to at least one second application, and the second code may include a plurality of second functions. The second history table 1152 may store a plurality of pieces of second history information respectively corresponding to the plurality of second functions.

In one example embodiment, the NPU 1180 may execute a third code corresponding to at least one third application, and the third code may include a plurality of third functions. The third history table 1153 may store a plurality of pieces of third history information respectively correspond to the plurality of third functions.

In one example embodiment, the random IP 1190 may execute a fourth code corresponding to at least one fourth application, and the fourth code may include a plurality of fourth functions. The fourth history table 1154 may store a plurality of pieces of fourth history information respectively corresponding to the plurality of fourth functions.

In one example embodiment, the performance controller 1140 may control performance of the CPU 1110 for each function executed by the CPU 1110 by using the first history table 1151, control performance of the GPU 1170 for each function executed by the GPU 1170 by using the second history table 1152, control performance of the NPU 1180 for each function executed by the NPU 1180 by using the third history table 1153, and control performance of the random IP 1190 for each function executed by the random IP 1190 by using the fourth history table 1154.

The CPU 1110, the GPU 1170, the NPU 1180, and the random IP 1190 may have different characteristics from each other. Herein, the characteristics may be defined as the type, maximum or improved performance, and so on of the functions executed by IP.

In one example embodiment, the performance controller 1140 may generate the first to fourth history tables 1151 to 1154 based on the characteristics of each of the CPU 1110, the GPU 1170, the NPU 1180, and the random IP 1190.

Any of the elements and/or functional blocks disclosed above may include or be implemented in processing circuitry such as hardware including logic circuits; a hardware/software combination such as a processor executing software; or a combination thereof. For example, CMU 120, PMU 130, performance controller 140, memory controller 820, performance controller 2110, application processor 2100, and NPU 1180 as well as performance measurement module 220, performance prediction module 230, function identification module 210, and performance management module 240 may be implemented as processing circuitry. The processing circuitry specifically may include, but is not limited to, a central processing unit (CPU), an arithmetic logic unit (ALU), a digital signal processor, a microcomputer, a field programmable gate array (FPGA)(it can be considered), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Processor(s), controller(s), and/or processing circuitry may be configured to perform actions or steps by being specifically programmed to perform those action or steps (such as with an ASIC or FPGA (it can be considered)) or may be configured to perform actions or steps by executing instructions received from a memory, or a combination thereof.

While the inventive concepts have been particularly shown and described with reference to example embodiments thereof, it will be understood that various changes in form and details may be made therein without departing from the spirit and scope of the following claims.

What is claimed is:

1. A system on chip comprising:
a processor configured to execute an application by using a shared library, the application being supported by an operating system,
a performance prediction module configured to
generate control information of the processor for executing a function by the processor and predictive performance information of the processor that is predicted during control according to the control information when the function included in the shared library is executed, the control information referencing a history corresponding to the function from a history table, and
a performance management module configured to generate a control signal for performance control of the processor based on the control information, and
wherein the history is an accumulation of performance information of the processor measured by executing in advance the function at least once.

2. The system on chip of claim 1, wherein the predictive performance information includes at least one of predicted consumption power information of the processor, predicted information on an operating voltage and an operating frequency to be provided in the processor, predicted temperature information of the processor, predicted throttling information of the processor, and information on an estimated measurement period.

3. The system on chip of claim 1, further comprising a performance measurement module configured to acquire actual performance information of the processor by measuring performance of the processor when the function is executed.

4. The system on chip of claim 3, wherein the actual performance information includes at least one of actual information on an operating voltage and an operating frequency applied to the processor when the function is executed, internal state monitoring information of the processor, temperature information of the processor, actual throttling information, and setting information on active clock gating, and utilization information of an execution module.

5. The system on chip of claim 3, wherein the performance prediction module determine reliability of the predictive performance information based on a result of comparing the predictive performance information with the actual performance information when the function is executed, identify whether the reliability of the predictive performance information is less than a threshold, and updates the history based on the actual performance information in response to the reliability of the predictive performance information being less than the threshold.

6. The system on chip of claim 5, wherein the performance prediction module link the updated history to a start address of the function and stores the history in the history table.

7. The system on chip of claim 1, wherein the performance prediction module and the performance management module are operated using an operating system executed by the processor.

8. An operating method of a system on chip, the operating method comprising:
executing an application by using a shared library, the application being supported by an operating system;
generating control information of a processor for executing a function and predictive performance information of the processor that is predicted during control according to the control information when the function included in the shared library is executed, the control information referencing a history corresponding to the function from a history table; and
generating a control signal for performance control of the processor based on the control information,
wherein the history is an accumulation of performance information of the processor measured by executing in advance the function at least once.

9. The operating method of claim 8, wherein the predictive performance information includes at least one of predicted consumption power information of the processor, predicted information on an operating voltage and an operating frequency to be provided in the processor, predicted temperature information of the processor, predicted throttling information of the processor, and information on an estimated measurement period.

10. The operating method of claim 8, further comprising:
acquiring actual performance information of the processor by measuring performance of the processor when the function is executed; and
determining reliability of the predictive performance information based on a result of comparing the predictive performance information with the actual performance information when the function is executed.

11. The operating method of claim 10, wherein the actual performance information includes at least one of actual information on an operating voltage and an operating frequency applied to the processor when the function is executed, internal state monitoring information of the processor, temperature information of the processor, actual throttling information, and setting information on active clock gating, and utilization information of an execution module.

12. The operating method of claim 10, further comprising:
identifying whether the reliability of the predictive performance information is less than a threshold, and
updating the history based on the actual performance information in response to the reliability of the predictive performance information being less than the threshold.

13. The operating method of claim 12, further comprising linking the updated history to a start address of the function and storing the history in the history table.

14. The operating method of claim 8, further comprising identifying whether the function is included in the shared library, based on call-return information of the function received from the processor.

15. An operating method of a system on chip, the operating method comprising:
executing an application supported by an operating system;
identifying whether a history corresponding to a function used to execute the application is present in a history table;
generating control information of a processor for executing the function and predictive performance information of the processor that is predicted during control according to the control information when the history corresponding to the function is present in the history table, the control information referencing the history corresponding to the function; and
generating a control signal for performance control of the processor based on the predictive performance information,
wherein the history is an accumulation of performance information of the processor measured by executing in advance the function at least once.

16. The operating method of claim 15, wherein the predictive performance information includes at least one of predicted consumption power information of the processor, predicted information on an operating voltage and an operating frequency to be provided in the processor, predicted temperature information of the processor, predicted throttling information of the processor, and information on an estimated measurement period.

17. The operating method of claim 15, further comprising:
acquiring actual performance information of the processor by measuring performance of the processor when the function is executed; and
determining reliability of the predictive performance information based on a result of comparing the predictive performance information with the actual performance information when the function is executed.

18. The operating method of claim 17, wherein the actual performance information includes at least one of actual information on an operating voltage and an operating frequency applied to the processor when the function is executed, internal state monitoring information of the processor, temperature information of the processor, actual throttling information, and setting information on active clock gating, and utilization information of an execution module.

19. The operating method of claim 17, further comprising:
identifying whether the reliability of the predictive performance information is less than a threshold, and
updating the history based on the actual performance information in response to the reliability of the predictive performance information being less than the threshold.

20. The operating method of claim 19, further comprising linking the updated history to a start address of the function and storing the history in the history table.
